(19) United States
(12) Patent Application Publication
(10) Pub. No.: US 2026/0116408 A1
(43) Pub. Date: Apr. 30, 2026

(54) METHOD AND APPARATUS FOR PATH PREDICTION OF VEHICLE BASED ON DRIVER INTENT

(71) Applicants: Hyundai Motor Company, Seoul (KR); Kia Corporation, Seoul (KR)

(72) Inventor: Sung Wook Lee, Hwaseong (KR)

(21) Appl. No.: 19/228,285

(22) Filed: Jun. 4, 2025

(30) Foreign Application Priority Data
Oct. 30, 2024 (KR) 10-2024-0150829

(51) Int. Cl. B60W 50/10; B60W 50/00; B60W 60/00

(52) U.S. Cl. CPC B60W 50/10; B60W 50/0097; B60W 60/001; B60W 2510/205; B60W 2520/06; B60W 2520/10; B60W 2520/105; B60W 2520/14; B60W 2540/10; B60W 2540/12; B60W 2540/16

(57) ABSTRACT

A method and apparatus for path prediction in a vehicle are useful for determining a driving intent of a driver. The method for predicting a path of the vehicle includes steps carried out by a processor, including: acquiring driving information of the vehicle; determining a longitudinal driving intent and a lateral driving intent of the driver based on the driving information; generating a velocity profile and a curvature profile of the vehicle based on the longitudinal driving intent and the lateral driving intent; and determining a predicted path of the vehicle based on the velocity profile and the curvature profile.

### CROSS-REFERENCE TO RELATED APPLICATION

This application claims under 35 U.S.C. § 119 (a) the benefit of Korean Patent Application No. 10-2024-0150829, filed on Oct. 30, 2024 in the Korean Intellectual Property Office, the entire contents of which are incorporated herein by reference.

### BACKGROUND

### (a) Technical Field

The present disclosure relates to a method and apparatus for performing path prediction of a vehicle based on a driver's intent, more particularly, to the method and apparatus for improving path prediction accuracy in situations where the vehicle is unable to obtain lane information.

### (b) Description of the Related Art

An autonomous driving system typically predicts a path of a subject vehicle for route planning, collision avoidance determination, etc. For example, the autonomous driving system may use the predicted path to calculate a possible collision between the autonomous vehicle and a neighboring object, warn the driver, perform avoidance control, etc.

If the autonomous vehicle can detect lanes of a road it is traveling on, the autonomous driving system can improve accuracy of path prediction based on lane information in the path prediction. On the other hand, if the autonomous vehicle cannot detect the lane(s), the existing autonomous driving system uses driving information of the subject vehicle, including velocity, acceleration, yaw rate, steering angle, etc. to predict the path of the subject vehicle based on a kinematic model.

Where the lane is undetectable and when the prediction time window is lengthy (e.g., greater than 4 seconds), the existing path prediction method calculates the amount of lateral movement and heading angle change of the autonomous vehicle as it moves away from the current time, to be larger than the driving intent of the driver. This means that the existing path prediction method has a limitation in the path prediction for a long prediction time window when the lane is undetectable.

### SUMMARY

The present disclosure is directed at providing a method and apparatus for performing path prediction with high accuracy, even in situations where the autonomous driving system cannot perceive lanes.

The present disclosure is also directed at providing a method and apparatus for performing path prediction over a lengthy prediction time window, even in situations where the autonomous driving system cannot perceive lanes.

Further, the present disclosure provides a method and apparatus that can improve path prediction accuracy by performing path prediction of an autonomous vehicle based on a driver's driving intent.

Technical objects to be achieved by the present disclosure are not limited to those described above, and other technical objects not mentioned above may also be clearly understood from the detailed descriptions given below by those skilled in the art to which the present disclosure belongs.

According to the present disclosure, a method for predicting a path of a vehicle includes: acquiring, by at least one processor of the vehicle, driving information of the vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle; determining, by the at least one processor, a longitudinal driving intent of a driver based on the driving information; determining, by the at least one processor, a lateral driving intent of the driver based on the driving information; generating, by the at least one processor, a velocity profile of the vehicle based on the longitudinal driving intent and the lateral driving intent; generating, by the at least one processor, a curvature profile of the vehicle based on the longitudinal driving intent and the lateral driving intent; and determining, by the at least one processor, a predicted path of the vehicle based on the velocity profile and the curvature profile.

According to another aspect of the present disclosure, a method for predicting a path of a vehicle includes: acquiring driving information of the vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle; determining a longitudinal driving intent of a driver based on the driving information; determining a lateral driving intent of the driver based on the driving information; generating a velocity profile of the vehicle based on the longitudinal driving intent and the lateral driving intent; generating a curvature profile of the vehicle based on the longitudinal driving intent and the lateral driving intent; and determining a predicted path of the vehicle based on the velocity profile and the curvature profile.

According to another embodiment, the present disclosure provides an apparatus for predicting a path of a vehicle, comprising: at least one memory configured to store instructions; and at least one processor, wherein the at least one processor executes the instructions for causing the at least one processor to: acquire driving information of the vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle; determine a longitudinal driving intent of a driver based on the driving information; determine a lateral driving intent of the driver based on the driving information; generate a velocity profile of the vehicle based on the longitudinal driving intent and the lateral driving intent; generate a curvature profile of the vehicle based on the longitudinal driving intent and the lateral driving intent; and determine a predicted path of the vehicle based on the velocity profile and the curvature profile.

According to at least one embodiment of the present disclosure, by generating a driving profile by identifying a driver's longitudinal driving intent and lateral driving intent, the autonomous vehicle can perform path prediction with high accuracy even in a situation where the autonomous vehicle cannot perceive lanes.

According to at least one embodiment of the present disclosure, by generating a driving profile by identifying the driver's longitudinal driving intent and lateral driving intent, path prediction can be performed with high accuracy even for a lengthy prediction time window.

A vehicle (e.g., an autonomous vehicle) may include the above-described apparatus.

According to a further aspect of the present disclosure, a non-transitory computer readable medium containing program instructions executed by a processor includes: program instructions that acquire driving information of a vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle; program instructions that determine a longitudinal driving intent of a driver based on the driving information; program instructions that determine a lateral driving intent of the driver based on the driving information; program instructions that generate a velocity profile of the vehicle based on the longitudinal driving intent and the lateral driving intent; program instructions that generate a curvature profile of the vehicle based on the longitudinal driving intent and the lateral driving intent; and program instructions that determine a predicted path of the vehicle based on the velocity profile and the curvature profile.

In certain aspects, a vehicle as described herein may be an autonomous vehicle.

In a fully autonomous vehicle or system, the vehicle may perform all driving tasks under all conditions and little or no driving assistance is required a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain embodiments, the present systems and vehicles may be fully autonomous. In other certain embodiments, the present systems and vehicles may be semi-autonomous.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a schematic block diagram of a path prediction apparatus according to at least one embodiment of the present disclosure.

FIG. 2 illustrates an example flow diagram used by a path prediction apparatus for determining a lateral driving intent, according to at least one embodiment of the present disclosure.

FIGS. 3A through 3C are diagrams illustrating how a profile generating unit determines a velocity profile of a vehicle.

FIGS. 4A through 4C are diagrams illustrating how the profile generating unit determines a curvature profile of the vehicle.

FIG. 5 is a flowchart illustrating a process by which the path prediction apparatus generates a predicted path of the vehicle, according to at least one embodiment of the present disclosure.

FIGS. 6A and 6B are diagrams for comparing a predicted path generated by a path prediction method according to at least one embodiment of the present disclosure against a predicted path generated by a conventional path prediction method.

FIG. 7 is a schematic block diagram of an illustrative computing device that may be used to implement the methods or apparatuses according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

As used herein, path prediction refers to a function of an autonomous driving system to predict the path of a vehicle, which may be an autonomous vehicle (also referred to herein as a “subject vehicle”).

In the present disclosure, a prediction time window refers to a time interval from the current time to a future time that the autonomous driving system is to predict. The length of the prediction time window may be expressed in units of time. For example, if the autonomous driving system predicts a path from the current time point to a future time point four seconds later, the prediction time window is four seconds long.

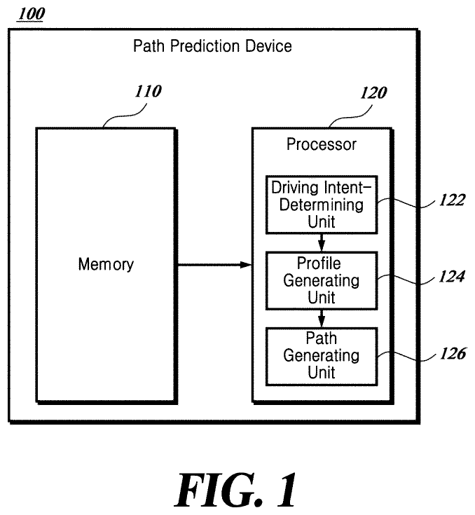

FIG. 1 is a schematic block diagram of a path prediction apparatus 100 according to at least one embodiment of the present disclosure.

The path prediction apparatus 100 includes a memory 110 and a processor 120.

The path prediction apparatus 100 may be implemented in the form of an embedded device, a server, an electronic device within an autonomous driving system, or the like. Not all of the blocks illustrated in FIG. 1 are requisite components, and some blocks included in the path prediction apparatus 100 may be added, changed, or deleted. Further, the components illustrated in FIG. 1 represent functionally classified elements, and at least one of the components may be implemented in a form that integrates in a real-world physical environment.

The memory 110 stores data and commands required for the operation of the path prediction apparatus 100.

The memory 110 may store driving information of the vehicle and road information obtained by using at least one sensor included in the vehicle. The vehicle driving information may include a vehicle velocity, acceleration, steering angle, steering angle velocity, heading angle, yaw rate, stepped amount of accelerator/brake pedal, and/or gear shift setting.

The processor 120 controls the overall operations of the path prediction apparatus 100. The processor 120 may be implemented as one or more processors. The processor 120 may execute instructions stored in the memory 110.

The processor 120 may include a driving intent-determining unit 122, a profile generating unit 124, and a path generating unit 126.

The driving intent-determining unit 122 may determine the driving intent of the driver based on the driving information of the vehicle stored in the memory 110. A driver's driving intent may be categorized into longitudinal driving intent and lateral driving intent. A longitudinal driving intent refers to the driver's intent to drive the vehicle at a high or low speed, to accelerate or decelerate rapidly, etc. A lateral driving intent indicates the driver's intent to or not to turn the vehicle to a certain degree, to or not to go straight, to or not to turn in the opposite direction, etc.

In at least one embodiment of the present disclosure, longitudinal driving intents may be categorized as Idle, LowSpd, HighSpd, RapidAcc, and the like. Table 1 describes definitions of different types of longitudinal driving intents.

TABLE 1

| Longitudinal | |
|---|---|
| Driving Intent | Explained |
| idle | No accelerator/brake pedal input and vehicle is in D or R |
| | gear |
| LowSpd | Low-speed driving with constant speed or small |
| | magnitude of acceleration/deceleration (v ≤ v_{ref} and |
| | a ≤ a_{ref}) |
| HighSpd | Medium/high-speed driving with constant speed or small |
| | magnitude of acceleration/deceleration (v > v_{ref} and |
| | a ≤ a_{ref}) |
| RapidAcc | Large magnitude of acceleration/deceleration (a > a_{ref}) |

The driving intent-determining unit 122 determines that the driver's longitudinal driving intent is Idle if the vehicle is in D gear or R gear, and there is no input from the accelerator pedal or the brake pedal of the vehicle. The driving intent-determining unit 122 determines the driver's longitudinal driving intent as LowSpd if the magnitude of the acceleration of the vehicle is less than or equal to a predetermined magnitude of acceleration a_{ref} and the velocity of the vehicle is less than or equal to a predetermined velocity V_{ref}. The driving intent-determining unit 122 determines that the driver's longitudinal driving intent is HighSpd if the magnitude of the acceleration of the vehicle is less than or equal to the predetermined magnitude of acceleration a_{ref} and the velocity of the vehicle is greater than the predetermined velocity V_{ref}. The driving intent-determining unit 122 determines the driver's longitudinal driving intent as RapidAcc if the magnitude of the acceleration of the vehicle is greater than the predetermined magnitude of acceleration a_{ref}.

In at least one embodiment of the present disclosure, the lateral driving intent may be categorized as Restore, SmoothTurn, Unknown, Turn, Counter, and the like. Table 2 describes definitions of the respective types of lateral driving intent.

TABLE 2

| Lateral Driving | |
|---|---|
| Intent | Explained |
| Restore | Steering angle θ is small in magnitude and yaw rate γ is opposite |
| | in sign to steering angle θ (θ ≤ θ_{ref1} and sgn(γ) ≠ sgn(θ)) |
| SmoothTurn | Steering angle θ and steering angle velocity \dot{θ} amounting to |
| | gentle rerouting levels (θ ≤ θ_{ref1} and \dot{θ} ≤ \dot{θ}_{ref1}) |
| Unknown | Difficult to distinguish whether it is a smooth or abrupt rerouting |
| Turn | Steering angle θ and steering angle velocity \dot{θ} amounting to |
| | abrupt rerouting levels (θ > θ_{ref2} and \dot{θ} > \dot{θ}_{ref2}) |
| Counter | Steering angle θ is large, and steering angle θ is opposite in sign |
| | to steering angle velocity \dot{θ} (θ > θ_{ref2} and sgn(θ) ≠ sgn(\dot{θ})) |

Smooth Turn indicates the driver's intent to change the route to a hypothetical route parallel to the currently traveled route. The driving intent-determining unit 122 determines that the driver's lateral driving intent is a SmoothTurn if the steering angle of the vehicle is less than or equal to a first predetermined steering angle θ_{ref1} and/or if the steering angle velocity of the vehicle is less than or equal to a first predetermined steering angle velocity \dot{θ}_{ref1}. The first predetermined steering angle and first predetermined steering angle velocity are set based on the steering angle and steering angle velocity that occur in a gentle change of route (e.g., lane change).

Restore indicates the driver's intent to finish the change of route to the virtual path and align the vehicle with the virtual path. The driving intent-determining unit 122 determines that the driver's lateral driving intent is Restore if the steering angle of the vehicle is less than or equal to the first predetermined steering angle θ_{ref1}, and the yaw rate of the vehicle is out of phase with the steering angle of the vehicle, i.e., the yaw rate is opposite in sign to the steering angle due to the phase lag of the yaw rate output.

Turn indicates the driver's intent to turn to a hypothetical path that is not parallel to the path the driver is currently traveling. The driving intent-determining unit 122 determines the driver's lateral driving intent as Turn if the steering angle of the vehicle is greater than a second predetermined steering angle θ_{ref2} and the steering angle velocity of the vehicle is greater than a second predetermined steering angle velocity θ_{ref2}. The second predetermined steering angle and the second predetermined steering angle velocity are set based on the steering angle and the steering angle velocity that occur in an abrupt change of route (e.g., a U-turn).

Counter indicates the driver's intent to correct the excessive steering input. The driving intent-determining unit 122 determines the driver's lateral driving intent as Counter if the steering angle of the vehicle is greater than the second predetermined steering angle θ_{ref2}, and the steering angle of the vehicle is out of phase with the steering angle velocity of the vehicle, i.e., the steering angle is opposite in sign to the steering angle velocity due to a phase lag of the steering angle output.

Unknown indicates a situation where it is unclear whether the driver's lateral driving intent is to make a smooth turn (SmoothTurn) or a sharp turn (Turn). The driving intent-determining unit 122 may determine that the driver's lateral driving intent is Unknown if the steering angle of the vehicle is greater than the first predetermined steering angle θ_{ref1} but less than or equal to the second predetermined steering angle θ_{ref2} and/or if the steering angle velocity of the vehicle is greater than the first predetermined steering angle velocity θ_{ref1} but less than or equal to the second predetermined steering angle velocity θ_{ref2}. The driving intent-determining unit 122 may determine the lateral driving intent as Unknown in other situations where it is difficult to determine whether the lateral driving intent is a Turn or a Smooth Turn.

Since the driving intent-determining unit 122 determines the lateral driving intent of the driver based on a hypothetical path in a situation where lane detection is not available, a flow diagram may be used to prevent an operation unintended by the driver.

As one example, Restore needs the precondition to be satisfied that the vehicle has a small steering angle. Thus, there may be a state transition from SmoothTurn to Restore, but not from Unknown, Turn, or Counter to Restore. As another example, Counter needs the precondition to be satisfied that the vehicle has a large steering angle. Thus, there may be a state transition from Turn to Counter, but not from Unknown, Smooth Turn, or Restore to Counter.

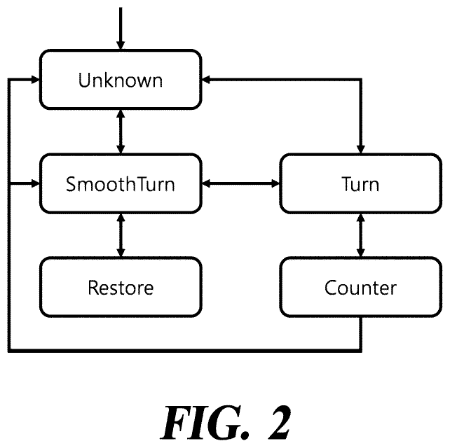

FIG. 2 illustrates an example flow diagram used by the path prediction apparatus 100 for determining a lateral driving intent, according to at least one embodiment of the present disclosure. At the beginning of the lateral driving intent determination, the driver's lateral driving intent is Unknown.

The driving intent-determination unit 122 changes the lateral driving intent from Unknown to Smooth Turn if the steering angle of the vehicle is less than or equal to the first predetermined steering angle θ_{ref1} and/or if the steering angle velocity of the vehicle is less than or equal to the first predetermined steering angle velocity \dot{θ}_{ref1}. Conversely, the driving intent-determination unit 122 changes the lateral driving intent from SmoothTurn to Unknown or Turn if the vehicle's steering angle is greater than the first predetermined steering angle θ_{ref1} and/or if the vehicle's steering angle velocity is greater than the first predetermined steering angle velocity \dot{θ}_{ref1}.

The driving intent-determination unit 122 changes the lateral driving intent from Unknown to Turn if the vehicle's steering angle is greater than the second predetermined steering angle θ_{ref2} and/or if the vehicle's steering angle velocity is greater than the second predetermined steering angle velocity \dot{θ}_{ref2}. Conversely, the driving intent-determination unit 122 changes the lateral driving intent from Turn to Unknown or SmoothTurn if the vehicle's steering angle is less than or equal to the second predetermined steering angle θ_{ref2} and/or if the vehicle's steering angle velocity is less than or equal to the second predetermined steering angle velocity \dot{θ}_{ref2}.

The driving intent-determining unit 122 may change the lateral driving intent from Smooth Turn to Restore if, while the lateral driving intent is SmoothTurn, the yaw rate is opposite in sign to the steering angle. Conversely, the driving intent-determining unit 122 may change the lateral driving intent from Restore to SmoothTurn if, while the lateral driving intent is Restore, the yaw rate and the steering angle have the same sign.

The driving intent-determining unit 122 may change the lateral driving intent from Turn to Counter if, while the lateral driving intent is Turn, the steering angle velocity is opposite in sign to the steering angle. Conversely, the driving intent-determining unit 122 may change the lateral driving intent from Counter to Turn if, while the lateral driving intent is Counter, the steering angle velocity and the steering angle have the same sign. Alternatively, the driving intent-determining unit 122 may change the lateral driving intent from Counter to SmoothTurn or Unknown if, while the lateral driving intent is Counter, the steering angle becomes less than or equal to the second predetermined steering angle θ_{ref2}.

The profile generating unit 124 may generate a velocity profile and a curvature profile for predicting the path of the vehicle based on the driver's longitudinal driving intent and/or lateral driving intent.

In the present disclosure, the velocity profile means information representing the velocity of the vehicle over time, and the curvature profile means information representing the curvature of the vehicle trace over time. The velocity profile and the curvature profile may be represented in the form of an array. For example, if the prediction time window is 4 seconds long and the driving velocity or driving curvature is predicted at 0.1-second intervals, the velocity profile or curvature profile may be composed of 41 elements.

In at least one embodiment of the present disclosure, the profile generating unit 124 may generate a velocity profile based on the driver's longitudinal driving intent. In at least one embodiment of the present disclosure, the profile generating unit 124 may adjust the velocity profile based on the driver's lateral driving intent. Various methods may be used to reflect the lateral driving intent in the velocity profile, such as multiplying by a correction factor, linear combination, etc.

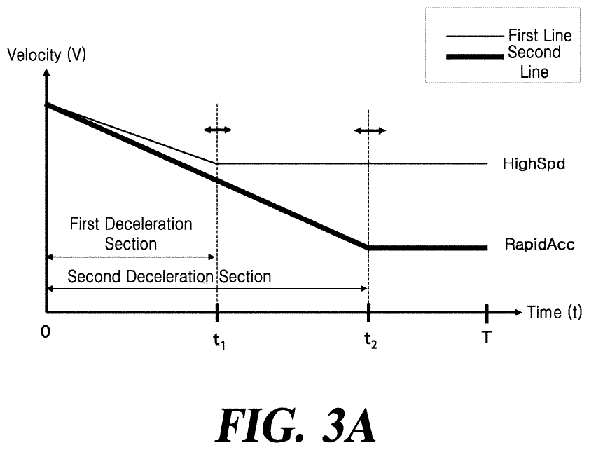

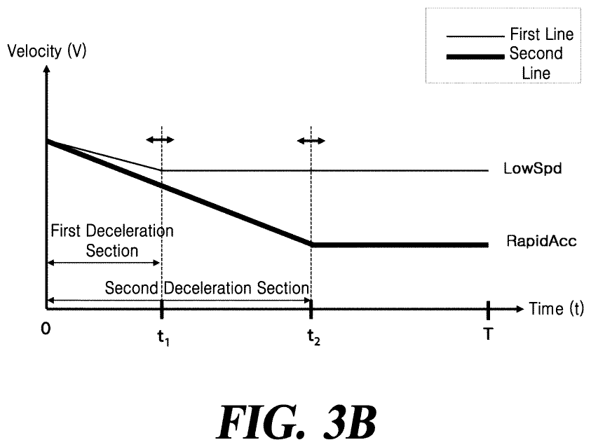

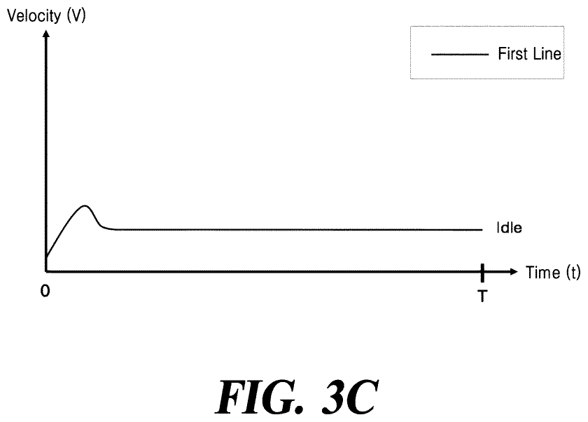

FIGS. 3A through 3C are diagrams illustrating a method performed by the profile generating unit 124 for determining the velocity profile of a vehicle by a linear combination. In FIGS. 3A through 3C, the horizontal axis of the graph represents future time points, the vertical axis of the graph represents the driving velocity of the vehicle, and T on the horizontal axis of the graph represents the length of the prediction time window.

FIG. 3A illustrates an example velocity profile graph generated by the profile generating unit 124 in a situation where a vehicle is traveling at a high speed and then decelerating.

In FIG. 3A, the first line represents a velocity profile with a longitudinal driving intent of HighSpd, and the second line represents a velocity profile with a longitudinal driving intent of RapidAcc. In a situation where a vehicle is traveling at a high speed and then decelerates, the driver's longitudinal driving intent is determined to be HighSpd if the magnitude of the deceleration is less than or equal to the predetermined acceleration a_{ref}, and the driver's longitudinal driving intent is determined to be RapidAcc if the magnitude of the deceleration is greater than the predetermined acceleration a_{ref}.

In FIG. 3A, the first deceleration section (0<t<t₁) is an interval in which a deceleration is reflected if the longitudinal driving intent is HighSpd. The second deceleration section (0<t<t₂) is an interval in which a deceleration is reflected if the longitudinal driving intent is RapidAcc. The profile generating unit 124 may generate the velocity profile by setting the first deceleration section differently from the second deceleration section. As an example, the second deceleration section may be set to be longer than the first deceleration section to reflect the driver's intent to significantly reduce the vehicle velocity if the longitudinal driving intent is RapidAcc.

Further, based on the driver's lateral driving intent, the profile generating unit 124 may adjust the initial velocity profile generated based on the driver's longitudinal driving intent. As an example, the profile generating unit 124 may generate the velocity profile in a manner that further increases the deceleration section (i.e., increases t₁ and t₂) if the driver's lateral driving intent is determined to be Turn or Counter.

FIG. 3B illustrates another example velocity profile graph generated by the profile generating unit 124 in a situation where the vehicle is traveling at a low speed and then decelerating.

In FIG. 3B, the first line represents a velocity profile with a longitudinal driving intent of LowSpd, and the second line represents a velocity profile with a longitudinal driving intent of RapidAcc. In a situation where a vehicle is traveling at a low speed and then decelerates, the driver's longitudinal driving intent is determined to be LowSpd if the magnitude of the acceleration is less than or equal to the predetermined acceleration a_{ref}, and the driver's longitudinal driving intent is determined to be RapidAcc if the magnitude of the acceleration is greater than the predetermined acceleration a_{ref}.

In FIG. 3B, the first deceleration section (0<t<t₁) is an interval in which a deceleration is reflected if the longitudinal driving intent is LowSpd, and the second deceleration section (0<t<t₂) is an interval in which a deceleration is reflected if the longitudinal driving intent is RapidAcc. The profile generating unit 124 may generate the velocity profile by setting the first deceleration section differently from the second deceleration section. As an example, the second deceleration section may be set to be longer than the first deceleration section to reflect the driver's intent to significantly reduce the vehicle velocity if the longitudinal driving intent is RapidAcc.

Further, based on the driver's lateral driving intent, the profile generating unit 124 may adjust the initial velocity profile generated based on the driver's longitudinal driving intent. As an example, the profile generating unit 124 may generate the velocity profile by increasing the deceleration section (i.e., increasing t₁ and t₂) if the driver's lateral driving intent is determined to be not Unknown.

FIG. 3C illustrates yet another example velocity profile graph generated by the profile generating unit 124 in a situation where the driver leaves the vehicle in a D gear or R gear and does not operate the accelerator pedal or brake pedal of the vehicle. In this situation, the driver's lateral driving intent is determined to be Idle. if the lateral driving intent is Idle, the profile generating unit 124 generates a velocity profile by describing a velocity characteristic curve during creep driving. In FIG. 3C, the first line represents, as an example, a velocity profile generated by depicting a velocity characteristic curve during creep driving.

In at least one embodiment of the present disclosure, the profile generating unit 124 may generate a curvature profile based on the driver's lateral driving intent. In at least one embodiment of the present disclosure, the profile generating unit 124 may adjust the curvature profile based on the driver's longitudinal driving intent. Various methods may be used to reflect the longitudinal driving intent in the curvature profile, such as multiplying by a correction factor, linear combination, etc.

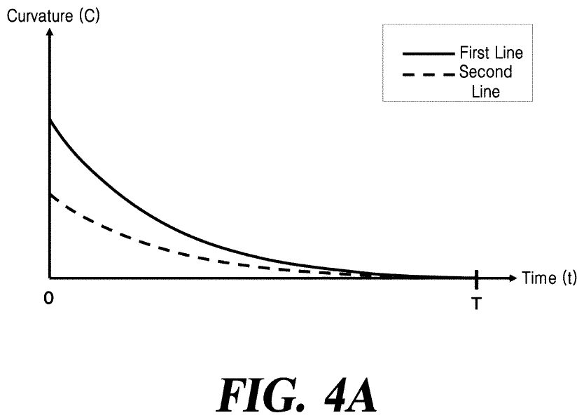

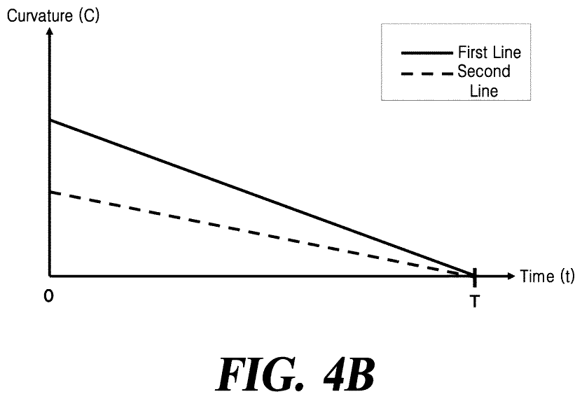

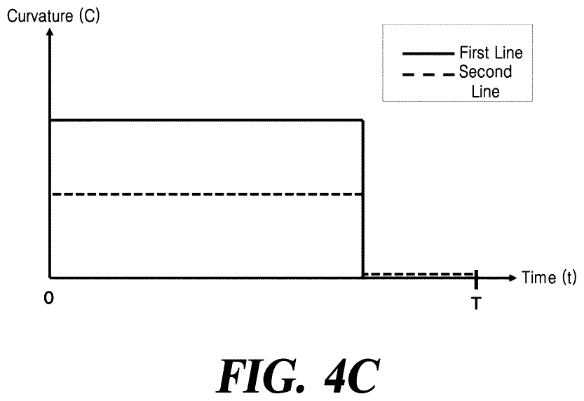

FIGS. 4A through 4C are diagrams illustrating a method performed by the profile generating unit 124 for determining a curvature profile of a vehicle by multiplying a correction factor. In FIGS. 4A to 4C, the horizontal axis of the graph represents future time points, the vertical axis of the graph represents the driving curvature of the vehicle, and T on the horizontal axis of the graph represents the length of the prediction time window.

FIG. 4A illustrates an example curvature profile graph generated by the profile generating unit 124 if the driver's lateral driving intent is Restore. In FIG. 4A, the first line represents a curvature profile generated based on the lateral driving intent, and the second line represents the curvature profile adjusted to reflect the longitudinal driving intent.

Since Restore is the driver's intent to finish the change of route to the virtual path and align the vehicle to the virtual path, the profile generating unit 124 may reflect this driver's intent by generating a curvature profile (first line in FIG. 4A) that is a curved attenuation, e.g., in the form of a quadratic function.

Further, based on the driver's longitudinal driving intent, the profile generating unit 124 may adjust the curvature profile generated based on the driver's lateral driving intent. In at least one embodiment of the present disclosure, the profile generating unit 124 may use, as the curvature profile, the resultant curvature profile after adjustment (second line in FIG. 4A) by multiplying the curvature profile generated based on the driver's lateral driving intent by a correction factor. The correction factor may have a value between 0 and 1. In one example, if the driver's longitudinal driving intent is LowSpd or Idle, the driving curvature may be larger, so the correction factor may be set to a value close to 1. In another example, if the driver's longitudinal driving intent is HighSpd or RapidAcc, the correction factor may be set to a value close to 0 because the driving curvature is unlikely to be large. The correction factor according to the longitudinal driving intent may be determined empirically.

FIG. 4B illustrates another example curvature profile graph generated by the profile generating unit 124 if the driver's lateral driving intent is SmoothTurn. In FIG. 4B, the first line represents a curvature profile generated based on the lateral driving intent, and the second line represents the curvature profile adjusted to reflect the longitudinal driving intent.

Since SmoothTurn is an intent to change the route to a hypothetical path parallel to the path the driver is currently traveling, the profile generating unit 124 may reflect this driver intent by generating a curvature profile (first line in FIG. 4B) that is a linear attenuation, e.g., in the form of a linear function.

Further, based on the driver's longitudinal driving intent, the profile generating unit 124 may adjust the curvature profile generated based on the driver's lateral driving intent. In at least one embodiment of the present disclosure, the profile generating unit 124 may use, as the curvature profile, the resultant curvature profile after adjustment (second line in FIG. 4B) by multiplying the curvature profile generated based on the driver's lateral driving intent by a correction factor. The correction factor may be the same value as the correction factor used in FIG. 4A, or it can be a different value. The correction factor according to the longitudinal driving intent may be determined empirically.

FIG. 4C illustrates yet another example curvature profile graph generated by the profile generating unit 124 if the driver's lateral driving intent is Counter. In FIG. 4C, the first line represents a curvature profile generated based on the lateral driving intent, and the second line represents the curvature profile adjusted to reflect the longitudinal driving intent.

Counter is the driver's intent to offset excessive steering input, so the profile generating unit 124 may reflect this driver intent by generating a curvature profile (first line in FIG. 4C) having a shape in which the curvature is constant and then drops to 0, e.g., in the form of a step function.

Further, based on the driver's longitudinal driving intent, the profile generating unit 124 may adjust the curvature profile generated based on the driver's lateral driving intent. In at least one embodiment of the present disclosure, the profile generating unit 124 may use, as the curvature profile, the resultant curvature profile after adjustment (second line in FIG. 4C) by multiplying the curvature profile generated based on the driver's lateral driving intent by a correction factor. The correction factor may be the same value as the correction factor used in FIG. 4A or FIG. 4B, or it may be a different value. The correction factor according to the longitudinal driving intent may be determined empirically.

If the driver's lateral driving intent is Turn or Unknown, the profile generating unit 124 generates a curvature profile with no change in curvature, i.e., a curvature profile with a constant form.

The path generating unit 126 predicts a path of the vehicle based on the velocity profile and the curvature profile. In the present disclosure, predicted path means information indicating the vehicle position (x, y) and heading angle (θ) over time, and may be represented in the form of an array. For example, if the prediction time window is 4 seconds long and the prediction time interval is 0.1 seconds, the predicted path may be composed of 41 elements.

In at least one embodiment of the present disclosure, the path generating unit 126 predicts a path of the vehicle by calculating the vehicle position and heading angle at each time point by using the vehicle position (X₀, Y₀) and heading angle (θ₀) at the current time point and the velocity profile and curvature profile.

Equation 1 is for the path generating unit 126 to utilize the vehicle position (Xₜ, Yₜ) and heading angle (Ot) at time t for calculating the vehicle position (Xₜ₊₁, Yₜ₊₁) and heading angle (θₜ₊₁) at a time (t+1).

$${X}_{t + 1} = {X}_{t} + {V}_{t} \cdot Δ t \cdot Cos ( {θ}_{t} ) \qquad [ Equation 1 ]$$

$${Y}_{t + 1} = {Y}_{t} + {V}_{t} \cdot Δ t \cdot Sin ( {θ}_{t} )$$

$${θ}_{t + 1} = {θ}_{t} + {ρ}_{t} \cdot {V}_{t} \cdot Δ t$$

In Equation 1, X and Y represent the positions of the vehicle, and θ represents the heading angle of the vehicle. V represents the velocity profile, and ρ represents the curvature profile of the vehicle. Δt represents a prediction time interval. As an example, if the prediction time window is 4 seconds long and the prediction time interval is 0.1 seconds, the path generating unit 126 calculates (X₀, Y₀, θ₀) through (X₄₀, Y₄₀, θ₄₀).

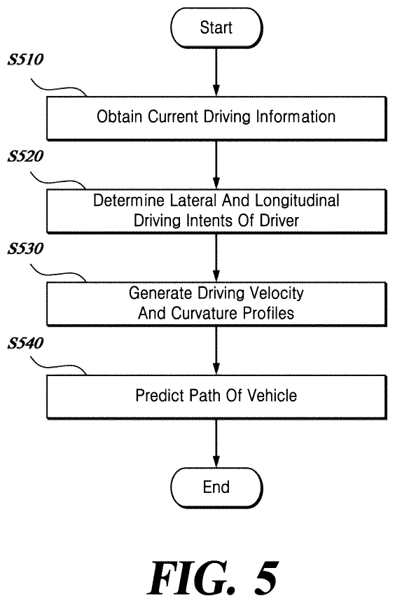

FIG. 5 is a flowchart illustrating a process by which the path prediction apparatus 100 generates a predicted path of a vehicle, according to at least one embodiment of the present disclosure.

The path prediction apparatus 100 obtains current driving information of the vehicle by using at least one sensor included in the vehicle (S510). The current driving information of the vehicle includes at least one of a vehicle velocity, an acceleration, a steering angle, a steering angle velocity, a heading angle, a yaw rate, a stepped amount of accelerator/brake pedal, idle information, or a gear shift setting.

The path prediction apparatus 100 determines a longitudinal driving intent and a lateral driving intent of the driver based on the current driving information of the vehicle (S520). In at least one embodiment, the path prediction apparatus 100 may determine the longitudinal driving intent based on the current vehicle velocity, acceleration, stepped amount of pedals, idle information, gear shift setting, etc. In at least one embodiment, the path prediction apparatus 100 may determine a lateral driving intent based on the vehicle's current steering angle, steering angle velocity, yaw rate, and the like.

The path prediction apparatus 100 generates a velocity profile and a curvature profile based on the driver's longitudinal driving intent and the lateral driving intent (S530). In at least one embodiment, the path prediction apparatus 100 may generate the velocity profile based on the driver's longitudinal driving intent and correct the velocity profile based on the lateral driving intent. In at least one embodiment, the path prediction apparatus 100 may generate a curvature profile based on the driver's lateral driving intent and correct the curvature profile based on the longitudinal driving intent.

The path prediction apparatus 100 predicts a path of the vehicle based on the velocity profile and the curvature profile (S540). In at least one embodiment, the path prediction apparatus 100 may predict the path of the vehicle by using Equation 1.

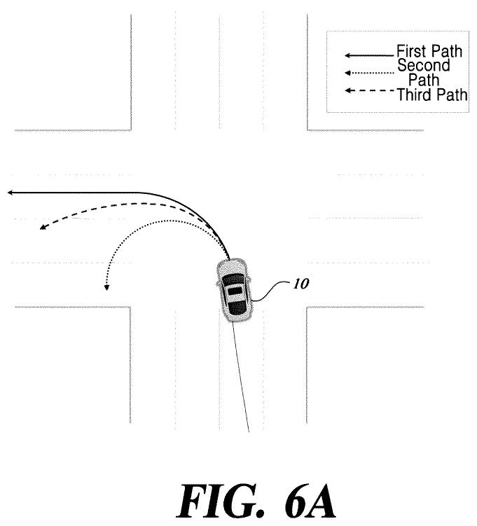

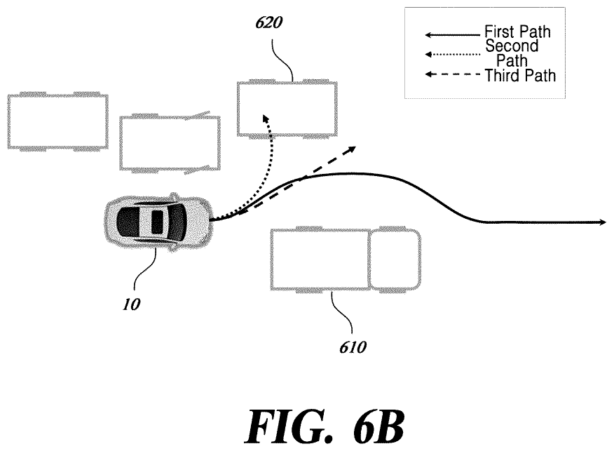

FIGS. 6A and 6B are diagrams for comparing a predicted path generated by a path prediction method according to at least one embodiment of the present disclosure against a predicted path generated by a conventional path prediction method.

FIG. 6A is an illustrative diagram for comparing a predicted path generated by the path prediction apparatus 100 with a predicted path generated by a conventional path prediction method in a situation where a subject vehicle 10 turns left at an intersection. In FIG. 6A, the first path represents the actual driving route of the vehicle, the second path represents the predicted path generated by a conventional path prediction apparatus, and the third path represents the predicted path generated by the path prediction method of the present disclosure.

The conventional path prediction method predicts a path based on a kinematic model when the intersection situation and lane information cannot be detected. In other words, the path prediction is performed under the assumption that the current velocity, yaw rate, etc. of the vehicle 10 remains the same at a future point in time, resulting in a generated path (second path) that deviates significantly from the actual driving path (first path).

On the other hand, the path prediction apparatus 100 of the present disclosure generates a predicted path based on the driver's longitudinal driving intent and lateral driving intent and thus can generate a path (third path) that does not deviate significantly from the actual driving path (first path). In FIG. 6A, the driver's lateral driving intent is determined to be SmoothTurn, and the driver's longitudinal driving intent is determined to be LowSpd. In this case, as in FIG. 4B, the curvature profile exhibits linear attenuation. Therefore, the predicted path (third path) generated by the path prediction method of the present disclosure gradually approaches a straight line, thereby generating a path that does not deviate significantly from the actual driving path (first path).

FIG. 6B is an illustrative diagram for comparing a predicted path generated by the path prediction apparatus 100 with a predicted path generated by a conventional path prediction method in a situation where the subject vehicle 10 is traveling on a narrow road, avoiding an obstacle 610. In FIG. 6B, the first path represents the actual driving path of the vehicle, the second path represents the predicted path generated by a conventional path prediction apparatus, and the third path represents the predicted path generated by the path prediction method of the present disclosure. FIG. 6B assumes that the subject vehicle 10 is driving in a situation where lanes are undetectable due to obstacles.

The conventional path prediction method predicts a path based on a kinematic model when the lanes are undetectable. In other words, the path prediction is performed under the assumption that the current velocity, yaw rate, etc. of the vehicle 10 remains the same at a future point in time, and thus generates a path (second path) that deviates significantly from the actual driving path (first path). If the autonomous vehicle makes a collision judgment based on the second path, it may make a judgment that it collides with another obstacle 620 located at the left front.

On the other hand, the path prediction apparatus 100 of the present disclosure generates a predicted path based on the driver's longitudinal driving intent and lateral driving intent, thereby generating a path (third path) that does not deviate significantly from the actual driving path (first path). In FIG. 6B, the driver's lateral driving intent is determined to be Restore, and the driver's longitudinal driving intent is determined to be LowSpd. In this case, as in FIG. 3A, the curvature profile exhibits an initial rapid drop. Therefore, the predicted path (third path) generated by the path prediction method of the present disclosure has a large curvature only at the beginning and quickly approaches a straight line, enabling the generation of a path that does not deviate significantly from the actual driving path (first path).

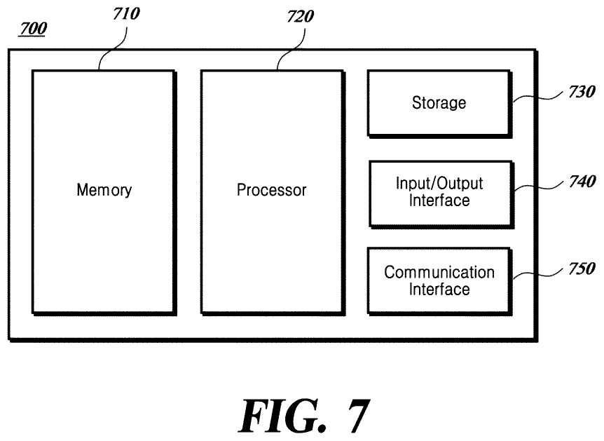

FIG. 7 is a schematic block diagram of an illustrative configuration of a computing device 700 that may be used to implement the methods or apparatuses according to the present disclosure.

The computing device 700 may include some or all of a memory 710, a processor 720, a storage 730, an input/output interface 740, and a communication interface 750. The computing device 700 may structurally and/or functionally include at least a portion of the path prediction apparatus 100. The computing device 700 may be a stationary computing device, such as a desktop computer, server, or the like, as well as a mobile computing device, such as a laptop computer, smartphone, or the like. The computing device 700 may include any specialized hardware accelerator capable of efficiently processing computations on AI models. For example, the computing device 700 may include a graphic processing unit (GPU), a tensor processing unit (TPU), or a neural processing unit (NPU).

The memory 710 may store programs that cause the processor 720 to perform methods or operations under various embodiments of the present disclosure. For example, the program may include a plurality of instructions executable by the processor 720 and the plurality of instructions may be executed by the processor 720 to perform the methods or operations described above. The memory 710 may be a single memory or a plurality of memories. In this case, the information required to perform the methods or operations according to various embodiments of the disclosure may be stored in a single memory or stored divisively among the plurality of memories. When the memory 710 is composed of a plurality of memories, they may be physically separated. The memory 710 may include at least one of volatile memory or non-volatile memory. The volatile memory may include static random access memory (SRAM) or dynamic random access memory (DRAM), for example, and the non-volatile memory may include flash memory, for example.

The processor 720 may include at least one core capable of executing at least one set of instructions. The processor 720 may execute instructions stored in the memory 710. The processor 720 may be a single processor or a plurality of processors.

The storage 730 maintains stored data even when power to the computing device 700 is interrupted. For example, the storage 730 may include non-volatile memory or may include a storage medium such as magnetic tape, optical disk, or magnetic disk. Programs stored in the storage 730 may be loaded into the memory 710 before execution by the processor 720. The storage 730 may store files written in a program language, and programs generated by a compiler or the like may be loaded from the files into the memory 710. The storage 730 may store data to be processed by the processor 720 and/or data that has been processed by the processor 720.

The input/output interface 740 may provide an interface with an input device, such as a keyboard, mouse, etc., and/or with an output device, such as a display device, printer, etc. A user can trigger the execution of a program by the processor 720 via the input device and/or view the results of processing by the processor 720 via the output device.

The communication interface 750 may provide access to an external network. The computing device 700 may communicate with other devices via the communication interface 750.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method for predicting a path of a vehicle, the method comprising:
acquiring, by at least one processor of the vehicle, driving information of the vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle;
determining, by the at least one processor, a longitudinal driving intent of a driver based on the driving information;
determining, by the at least one processor, a lateral driving intent of the driver based on the driving information;
generating, by the at least one processor, a velocity profile of the vehicle based on the longitudinal driving intent and the lateral driving intent;
generating, by the at least one processor, a curvature profile of the vehicle based on the longitudinal driving intent and the lateral driving intent; and
determining, by the at least one processor, a predicted path of the vehicle based on the velocity profile and the curvature profile.

2. The method of claim 1, wherein determining the longitudinal driving intent comprises determining that the longitudinal driving intent is a first longitudinal driving intent if a magnitude of the acceleration of the vehicle is greater than a predetermined magnitude of acceleration,
wherein the first longitudinal driving intent is that the driver intends to accelerate or decelerate rapidly.

3. The method of claim 2, wherein determining the longitudinal driving intent further comprises:
determining whether the velocity of the vehicle is equal to or lower than a predetermined velocity if the magnitude of the acceleration of the vehicle is equal to or lower than the predetermined magnitude of acceleration; and
determining that the longitudinal driving intent is a second longitudinal driving intent if the velocity of the vehicle is equal to or lower than the predetermined velocity, and determining that the longitudinal driving intent is a third longitudinal driving intent if the velocity of the vehicle is greater than the predetermined velocity,
wherein the second longitudinal driving intent is that the driver intends to drive at a low velocity, and the third longitudinal driving intent is that the driver intends to drive at a non-low velocity.

4. The method of claim 3, wherein determining the longitudinal driving intent further comprises determining that the longitudinal driving intent is a fourth longitudinal driving intent if the gear shift setting of the vehicle is to D gear or R gear and there is no input from the accelerator pedal or the brake pedal of the vehicle,
wherein the fourth longitudinal driving intent is that the driver intends to creep drive.

5. The method of claim 4, wherein determining the lateral driving intent comprises:
determining that the lateral driving intent is a first lateral driving intent if the steering angle of the vehicle is equal to or less than a first predetermined steering angle or if the steering angle velocity of the vehicle is equal to or less than a first predetermined steering angle velocity;
determining that the lateral driving intent is a second lateral driving intent if the steering angle of the vehicle is greater than a second predetermined steering angle or the steering angle velocity of the vehicle is greater than a second predetermined steering angle velocity; and
determining that the lateral driving intent is a third lateral driving intent if the lateral driving intent is not the first lateral driving intent or the second lateral driving intent, wherein the first lateral driving intent is that the driver intends to make a gentle change of route, and the second lateral driving intent is that the driver intends to make an abrupt change of route.

6. The method of claim 5, wherein determining the lateral driving intent further comprises:
if the lateral driving intent is determined to be the first lateral driving intent, determining whether the yaw rate of the vehicle is opposite in sign to the steering angle of the vehicle; and
if the yaw rate of the vehicle is opposite in sign to the steering angle of the vehicle, determining that the lateral driving intent is a fourth lateral driving intent.

7. The method of claim 6, wherein determining the lateral driving intent further comprises:
if the lateral driving intent is determined to be the second lateral driving intent, determining whether the steering angle of the vehicle is opposite in sign to the steering angle velocity of the vehicle; and
if the steering angle of the vehicle is opposite in sign to the steering angle velocity of the vehicle, determining that the lateral driving intent is a fifth lateral driving intent.

8. The method of claim 7, wherein generating the velocity profile comprises:
generating an initial velocity profile based on the longitudinal driving intent; and
adjusting the initial velocity profile based on the lateral driving intent.

9. The method of claim 8, wherein the velocity profile comprises an acceleration section, deceleration section and a constant velocity section, and
wherein generating the velocity profile based on the longitudinal driving intent comprises determining a length of each of the acceleration section, deceleration section and the constant velocity section based on the longitudinal driving intent.

10. The method of claim 9, wherein adjusting the initial velocity profile based on the lateral driving intent comprises adjusting the length of each of the acceleration section and deceleration section according to the lateral driving intent.

11. The method of claim 7, wherein generating the curvature profile comprises:
generating an initial curvature profile based on the lateral driving intent; and
adjusting the initial curvature profile based on the longitudinal driving intent.

12. The method of claim 11, wherein the initial curvature profile is in a form of a linear function if the lateral driving intent is determined to be the first lateral driving intent, in a form of a constant function if the lateral driving intent is determined to be the second or the third lateral driving intent, in a form of a quadratic function if the lateral driving intent is determined to be the fourth lateral driving intent, and in a form of a step function if the lateral driving intent is determined to be the fifth lateral driving intent.

13. The method of claim 12, wherein adjusting the curvature profile based on the longitudinal driving intent comprises multiplying the curvature profile by a correction factor, wherein the correction factor is a value between 0 and 1 and is determined based on the longitudinal driving intent.

14. An apparatus for predicting a path of a vehicle, comprising:
at least one memory configured to store instructions; and
at least one processor,
wherein the at least one processor executes the instructions for causing the at least one processor to:
acquire driving information of the vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle;
determine a longitudinal driving intent of a driver based on the driving information;
determine a lateral driving intent of the driver based on the driving information;
generate a velocity profile of the vehicle based on the longitudinal driving intent and the lateral driving intent;
generate a curvature profile of the vehicle based on the longitudinal driving intent and the lateral driving intent; and
determine a predicted path of the vehicle based on the velocity profile and the curvature profile.

15. A vehicle comprising the apparatus of claim 14.

16. An autonomous vehicle comprising the apparatus of claim 14.

17. A non-transitory computer readable medium containing program instructions executed by a processor, the computer readable medium comprising:
program instructions that acquire driving information of a vehicle, wherein the driving information comprises at least one of a velocity, an acceleration, a steering angle, a steering angle velocity, a heading angle, a yaw rate, a stepped amount of an accelerator pedal and a brake pedal, or a gear shift setting of the vehicle;
program instructions that determine a longitudinal driving intent of a driver based on the driving information;
program instructions that determine a lateral driving intent of the driver based on the driving information;
program instructions that generate a velocity profile of the vehicle based on the longitudinal driving intent and the lateral driving intent;
program instructions that generate a curvature profile of the vehicle based on the longitudinal driving intent and the lateral driving intent; and
program instructions that determine a predicted path of the vehicle based on the velocity profile and the curvature profile.
